(19) United States
(12) Patent Application Publication
(10) Pub. No.: US 2009/0319258 A1
(43) Pub. Date: Dec. 24, 2009

(54) METHOD AND SYSTEM FOR SPELL CHECKING IN TWO OR MORE LANGUAGES

(76) Inventor: Steven J. SHAER, Miami, FL (US)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/144,922

(22) Filed: Jun. 24, 2008

(51) Int. Cl. G06F 17/20

(52) U.S. Cl. 704/8

(57) ABSTRACT

A system, method and computer program product for multi-language word spelling verification and correction, including providing one or more spelling dictionaries and spelling rules for two or more languages; selecting two or more languages for use with the one or more spelling dictionaries and spelling rules; and performing verification and correction words of a document or data entry field written in the two or more languages based on the selected two or more languages using the one or more spelling dictionaries and spelling rules.

### BACKGROUND OF THE INVENTION

1. Field of the Invention

The present invention generally relates to spell checking systems and methods, and more particularly to a method and system for spell checking of a document, data entry field, and the like, written in mixture of two or more languages.

2. Discussion of the Background

Spell checking systems and methods (e.g., spell checkers, etc.) have been in use since the earliest days of computers, including applications in word processing, text editing, and the like. Spelling and grammar checking software facilities followed shortly after the advent of word processors, as a natural extension of their functionality. Such systems and features and have been ubiquitous in word processing for decades. Nowadays, the use of spell checking and grammar checking software has been extended to a much broader range of textual computer and Internet inputs, including email, Internet data entry forms, calendars, personal digital assistants, and the like.

However, typically what is not accommodated in the existing systems is the ability to process documents written in a blend of several languages. For example, a writer's primary language may be Spanish, but they imbed many English language words in their writing. Likewise, a writer might imbed English words from the domain of technology or pop culture inside the body of a Russian language document or correspondence. People of mixed heritage or recent immigrant backgrounds around the world write personal family correspondence in a similar blend of languages, blending the writer's old and new adopted languages. In addition, business people write international business correspondence in such a blend of languages, where certain technical terms are more common in one language than another.

Thus, current word processors and other computer applications, although allowing the user to select the user's default language for the use of the application and/or an individual document's specific language, which is also used for spell checking, the spell checking dictionary, spelling and grammar rules, and the like, do not allow for the use a blend of two or more languages. Accordingly, existing applications suffer from the assumption that writer will only be writing in only one of the selected languages.

### SUMMARY OF THE INVENTION

Therefore, there is a need for a method and system for spell checking of documents that are written in mixture of two or more languages to address the above and other problems with conventional spell checking systems and methods.

The above and other needs are addressed by exemplary embodiments of the present invention, which provide a novel method and system for word spelling verification and correction for writers writing in two or more languages within the same document, data entry application, and the like. For example, the user can specify a language set made up of a primary language and one or more secondary languages (e.g., a hierarchical language set, etc.), a language set made up of a group of languages to be considered equally (e.g., a parallel language set, etc.), and the like. Then, the verification and correction of the spelling of words in a document or other data entry application is performed within the context that some of the words may not just be misspelling, but rather may be properly spelled in one of the other selected languages. Advantageously, this allows for effective spelling verification, correction, editing, and the like, capabilities for writers who write in a mix of two or more languages.

Accordingly, in one aspect, a system, method and computer program product for multi-language word spelling verification and correction are provided, including providing one or more spelling dictionaries and spelling rules for two or more languages; selecting two or more languages for use with the one or more spelling dictionaries and spelling rules; and performing verification and correction words of a document or data entry field written in the two or more languages based on the selected two or more languages using the one or more spelling dictionaries and spelling rules.

Still other aspects, features, and advantages of the present invention are readily apparent from the following detailed description, simply by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary process for a user to select a mode of operation and languages;

FIG. 2 illustrates an exemplary process for a Hierarchical Language Mode; and

FIG. 3 illustrates an exemplary process for a Parallel Language Mode.

### DETAILED DESCRIPTION OF THE PREFERRED EMBODIMENTS

Generally, the novel method and system can be used for checking the spelling of a writing having been written in a blend or composite of languages, such that the input is made up of words of a range of languages, and wherein a Hierarchical Language Mode and a Parallel Language Mode are provided. In the Hierarchical Language Mode, the user selects a primary language and one or more secondary languages. If the word being verified and corrected is not found as correct in a primary language spelling dictionary and/or spelling rules, the word in then processed in the user's selected secondary language(s). Words that are processed successfully in the primary language are identified as spelled correctly. Words that are not processed successfully in the primary language, but are processed successfully in one of the other selected secondary language(s) are highlighted, identified, and the like, in any of suitable manners so that the user or the system can know that the process has failed in the primary language and in which of the selected languages the process was successful. Advantageously, a word correction suggestion is provided for all of the selected languages.

For example, if the user's primary language is English and the secondary language is Spanish and the target word is a valid Spanish word that is not found in the English dictionary, the word can be highlighted, identified, and the like, such that the user can easily see that the word is correct in Spanish. If the word is not valid in either English or Spanish, the word can be highlighted, identified, and the like, in a different manner so that the user can immediately know that the word has failed in the spell check of both languages. If a word is highlighted, the user can activate a dropdown menu that gives the user word suggestions in either applicable language.

In the Parallel Language Mode, the user specifies two or more languages and words are verified and corrected against the spelling dictionaries and/or spelling rules for all the selected languages. Words are either identified as to which languages in which they are correctly spelled or identified as spelled correctly if the word passes any of the languages selected. Spelling correction aids are provided and allow the user to specify which languages to use in suggesting the correct spellings.

In the context of the present invention, the term “language” need not only include spoken languages, but rather can also include industry specific lexicons, technology lexicons, any other suitable lexicons, and the like. In addition, the term “document” can include text in any suitable applications that take text as its input, for example, including web browser forms, calendar applications, other special purpose designed applications, and the like.

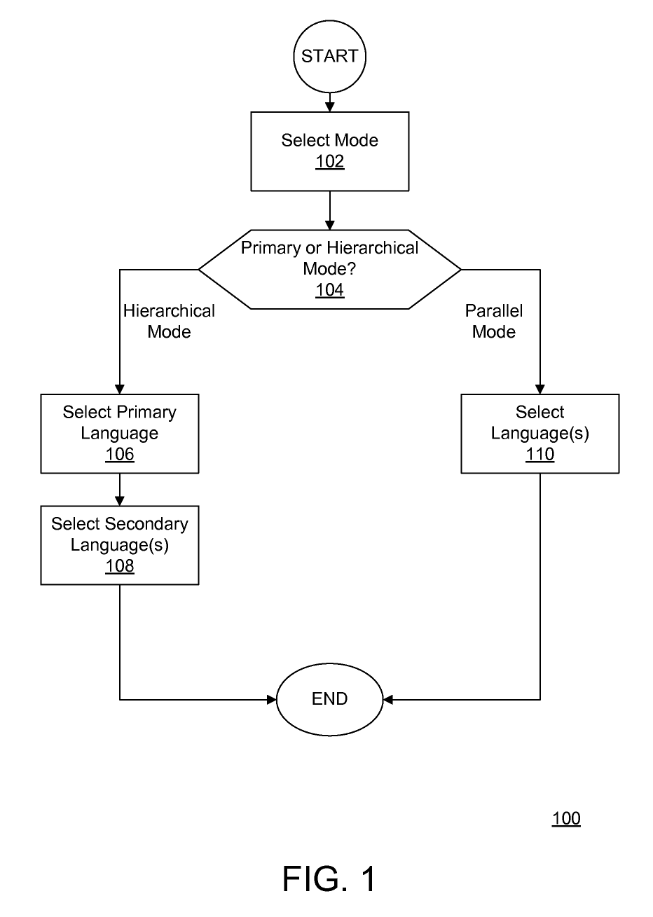

Referring now to the drawings, wherein like reference numerals designate identical or corresponding parts throughout the several views, and more particularly to FIG. 1 thereof, there is illustrated an exemplary process 100 for a user to select a mode of operation and languages. In FIG. 1, at step 102, a user selects a mode of operation, for example, including a Hierarchical Language Mode or Parallel Language Mode, as determined by step 104. If in Hierarchical Language Mode, at step 106, the user selects a primary language, and at step 108, the user selects one or more secondary languages, as either a default for the application or for the individual data entry, be it a document entry, a data input field entry, a calendar entry, and the like, completing the process. If, however, as determined at step 104, the user selects a Parallel Language Mode, at step 110, the user selects a group of two or more languages, completing the process.

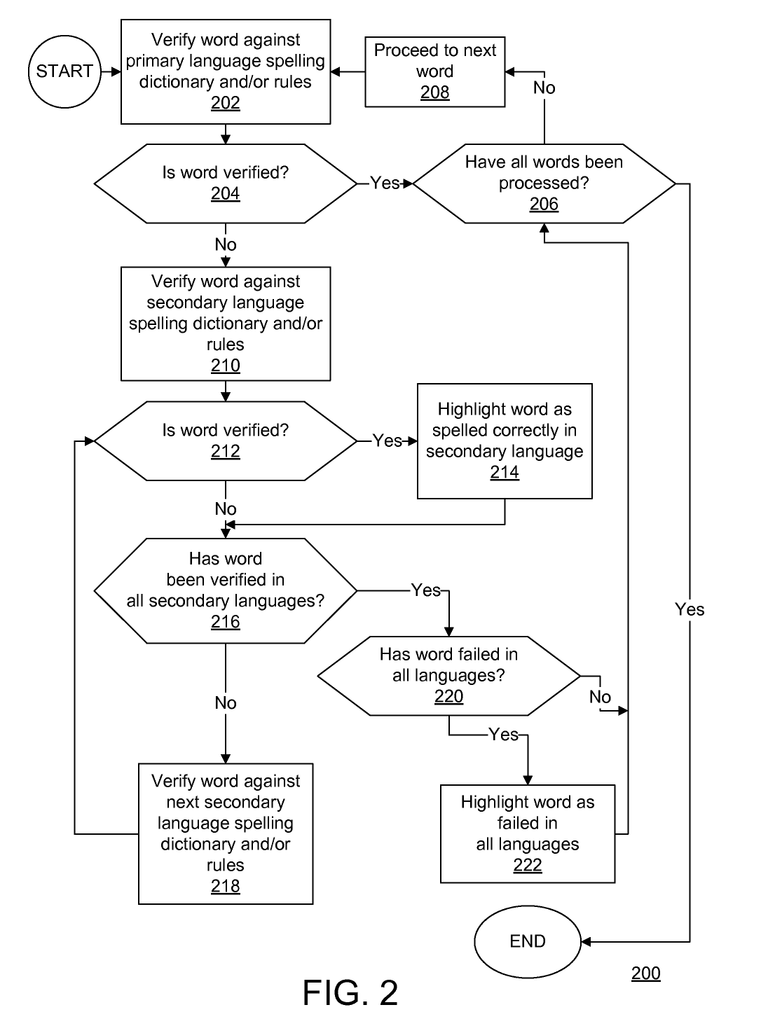

FIG. 2 illustrates an exemplary process 200 for a Hierarchical Language Mode. In FIG. 2, the user has previously selected the Hierarchical Language Mode, based on the exemplary process 100 of FIG. 1, and at step 202 a word in the document, data field, and the like, is verified against the primary language spelling dictionary and/or rules and control is transferred to step 204. Step 204 determines if the word is verified in the primary language. If the word is verified in the primary language, as determined by step 204, control is transferred to step 206. Step 206 determines if all of the words have been processed. If all of the words have not been processed, as determined by step 206, control is transferred to step 208. Step 208 determines the next word and transfers control back to step 202 to verify the next word against the primary language. Otherwise, if all the words have been processed, as determined by step 206, the processing is complete.

If, however, the word is not verified in the primary language, as determined in step 204, control is transferred to step 210. Step 210 verifies the word against the first (and possibly the only) secondary language spelling dictionary and/or rules and control is transferred to step 212. Step 212 verifies the word as spelled correctly in the secondary language. If step 212 determines that word is spelled correctly in the secondary language, control is transferred to step 214. In step 214, the word is identified, highlighted, and the like, as spelled correctly in the secondary language and control is transferred to step 216. Step 216 determines if the word has been verified in all of the secondary languages. If, however, the word is verified as not spelled correctly in the secondary language, as determined by step 212, then control also is transferred to step 216. If step 216 determines that the word has been verified in all of the secondary languages, control is transferred to step 220. Step 220 determines if the word has failed verification in all of the languages. If step 220 determines that the word has failed verification in all of the languages, control is transferred to step 222. In step 222, the word is identified, highlighted, and the like, as having failed verification in all of the languages and control is transferred back to step 206 to determine if all of the words have been processed. If step 220 determines that the word has not failed verification in all of the languages, control also is transferred to step 206 to determine if all of the words have been processed.

If, however, step 216 determines that the word has not been verified in all of the secondary languages, control is transferred to step 218. Step 218 verifies the word in the next of the secondary languages (if any) and control is transferred back to step 212 to verify the word as spelled correctly in the next secondary language.

Accordingly, all words that fail verification in the primary language are processed against all secondary languages. Advantageously, if a word is not verified in the primary language dictionary and/or rules, but is verified in more than one secondary language, the word can be uniquely identified, highlighted, and the like, so as to indicate that the word has been verified as correct against a particular combination of the selected languages. For example, a first unique color can be defined for words having spelling or rules errors in the primary language and which do not pass any of the secondary languages, and with another unique color for words passing each of the respective secondary languages. Similarly, another unique color can be defined to identify, highlight, and the like, when a word fails in the primary language, but passes on several or all of the secondary languages.

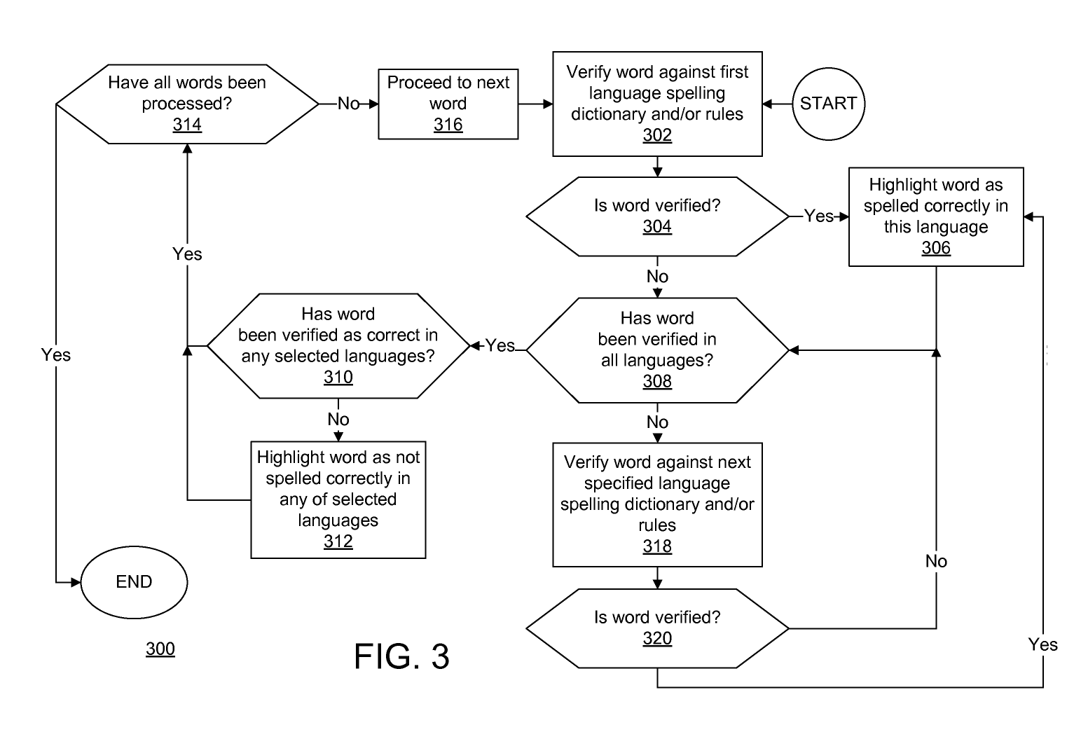

FIG. 3 illustrates an exemplary process 300 for a Parallel Language Mode. In FIG. 3, the user has previously selected the Parallel Language Mode, based on the exemplary process 100 of FIG. 1. If the user has selected the Parallel Language Mode, words are identified, highlighted, and the like, to show in which languages they are spelled correctly, or to show that they not spelled correctly in any of the selected languages. In FIG. 3, at step 302 a word in the document, data field, and the like, is verified against the spelling dictionary and/or rules of the first selected language and control is transferred to step 304. Step 304 determines if the word is verified against the first selected language. If the word is verified against the first selected language, as determined by step 304, control is transferred to step 306. In step 306, the word is highlighted, identified, and the like, as correctly spelled in the first language and control is transferred to step 308. Step 308 determines whether or not the word has been processed for all of the selected languages. If, however, the word has not been verified as correctly spelled in the first language, as determined by step 304, control also is transferred to step 308.

If the word has been processed against all the selected languages, as determined by step 308, control is transferred to step 310. Step 310 determines if the word has been spelled correctly in any of the languages. If the word has not been spelled correctly in any of the languages, control is transferred to step 312. In step 312, the word is highlighted, identified, and the like, to indicate that the word is not spelled correctly in any of the selected languages, and control is transferred to step 314. Step 314 determines if all of the words have been processed. If all of the words have not been processed, as determined by step 314, control is transferred to step 316. Step 316 determine the next word and transfers control back to step 302 for the next word in the document, data field, and the like, to be verified against the spelling dictionary and/or rules of the first selected language. If all of the words have been processed, as determined by step 314, the process is complete.

If, however, step 308 determines that the word has not been processed against all of the selected languages, control is transferred to step 318. Step 318 verifies the word against the next of the selected languages and control is transferred to step 320. If the word is verified against the next language, as determined by step 320, control is transferred back to step 306, where the word is highlighted, identified, and the like, as correctly spelled in the next language. If the word is not verified against the next language, as determined by step 320, control is transferred back to step 308 to determine whether or not the word has been processed for all of the selected languages.

Accordingly, all words that fail verification in the first language are processed against all next languages. Advantageously, if a word is not verified in the first language dictionary and/or rules, but is verified in more than one next language, the word can be uniquely identified, highlighted, and the like, so as to indicate that the word has been verified as correct against a particular combination of the selected languages. For example, a first unique color can be defined for words having spelling or rules errors in the first language and which do not pass any of the next languages, and with another unique color for words passing each of the respective next languages. Similarly, another unique color can be defined to identify, highlight, and the like, when a word fails in the first language, but passes on several or all of the next languages.

The above-described exemplary embodiments can be accessed by or included in, for example, any suitable clients, workstations, PCs, laptop computers, PDAs, Internet appliances, handheld devices, cellular telephones, wireless devices, other devices, and the like, capable of accessing or employing the exemplary embodiments. The exemplary embodiments can communicate using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the exemplary embodiments are for exemplary purposes, as many variations of the specific hardware used to implement the exemplary embodiments are possible, as will be appreciated by those skilled in the relevant art(s). For example, the functionality of one or more of the exemplary embodiments can be implemented via one or more programmed computer systems or devices.

To implement such variations as well as other variations, a single computer system can be programmed to perform the special purpose functions of the exemplary embodiments. On the other hand, two or more programmed computer systems or devices can be substituted for any one of the exemplary embodiments. Accordingly, principles and advantages of distributed processing, such as redundancy, replication, and the like, also can be implemented, as desired, to increase the robustness and performance of the exemplary embodiments.

The exemplary embodiments can store information relating to various processes described herein. This information can be stored in one or more memories, such as a hard disk, optical disk, magneto-optical disk, RAM, and the like, of the exemplary embodiments. One or more databases of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the exemplary embodiments in one or more databases thereof.

All or a portion of the exemplary embodiments can be conveniently implemented using one or more general purpose computer systems, microprocessors, digital signal processors, micro-controllers, and the like, programmed according to the teachings of the exemplary embodiments, as will be appreciated by those skilled in the computer and software arts. Appropriate software can be readily prepared by programmers of ordinary skill based on the teachings of the exemplary embodiments, as will be appreciated by those skilled in the software art. Further, the exemplary embodiments can be implemented on the World Wide Web. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments can include software for controlling the exemplary embodiments, for driving exemplary embodiments, for enabling the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present invention have been described in connection with a number of exemplary embodiments and implementations, the present invention is not so limited but rather covers various modifications and equivalent arrangements, which fall within the purview of the appended claims.

What is claimed is:

1. A computer implemented multi-language word spelling verification and correction method, the method comprising:
providing one or more spelling dictionaries and spelling rules for two or more languages;
selecting two or more languages for use with the one or more spelling dictionaries and spelling rules; and
performing verification and correction words of a document or data entry field written in the two or more languages based on the selected two or more languages using the one or more spelling dictionaries and spelling rules.

2. The method of claim 1, further comprising:
selecting a primary language and one or more secondary languages for use with the one or more spelling dictionaries and spelling rules; and
performing verification and correction words of a document or data entry field written in the primary language and the one or more secondary languages based on the selected primary language and the one or more secondary languages using the one or more spelling dictionaries and spelling rules.

3. The method of claim 1, further comprising performing the verification based on user selected prioritization rules.

4. The method of claim 1, further comprising displaying to a user a target word of the words of the document or the data entry field that is verified and corrected.

5. The method of claim 2, further comprising:
verifying and correcting spelling of the words of the document or the data entry field against the primary language based on the one or more spelling dictionaries and spelling rules;
indicating words that are spelled incorrectly in the primary language; and
verifying and correcting spelling of the words indicated as being spelled incorrectly in the primary language against the one or more secondary languages.

6. The method of claim 2, further comprising:
verifying spelling of a word of the words of the document or the data entry field against the primary language; and
if the word is verified as spelled correctly in the primary language, processing a next word of the words of the document or the data entry field against the primary language.

7. The method of claim 2, further comprising:
verifying spelling of a word of the words of the document or the data entry field against the primary language;
if the word is verified as not spelled correctly in the primary language, verifying spelling of the word against the one or more secondary languages;
if the word is verified as spelled correctly in the one or more secondary languages, highlighting the word in the document or the data entry field to uniquely indicate in which of the one or more secondary languages the word is spelled correctly; and
if the word is verified as not spelled correctly in the one or more secondary languages, highlighting the word in the document or the data entry field to uniquely indicate that the word is not spelled correctly in the primary language and the one or more secondary languages.

8. The method of claim 1, further comprising providing spelling suggestions for a word of the words of the document or the data entry field based on the languages selected and a manner in which the languages are selected.

9. The method of claim 1, further comprising:
verifying and correcting spelling of a word of the words of the document or the data entry field against the selected two or more languages based on the one or more spelling dictionaries and spelling rules; and
uniquely indicating in the document or the data entry field in which of the one or more spelling dictionaries the word is found.

10. The method of claim 9, further comprising highlighting the word in the document or the data entry field to uniquely indicate in which of the one or more spelling dictionaries the word is found.

11. The method of claim 1, further comprising:
verifying and correcting spelling of a word of the words of the document or the data entry field against the selected two or more languages based on the one or more spelling dictionaries and spelling rules;
if the word is found in the one or more spelling dictionaries and spelling rules, processing a next word of the words of the document or the data entry field against the selected two or more languages based on the one or more spelling dictionaries and spelling rules; and
if the word is not found in the one or more spelling dictionaries and spelling rules, uniquely indicating in the document or the data entry field that the word is not found in the one or more spelling dictionaries and spelling rules.

12. The method of claim 11, further comprising highlighting the word in the document or the data entry field to uniquely indicate that the word is not found in the one or more spelling dictionaries and spelling rules.

13. A computer implemented system for multi-language word spelling verification and correction, the system comprising:
one or more spelling dictionaries and spelling rules for two or more languages;
means for selecting two or more languages for use with the one or more spelling dictionaries and spelling rules; and
means for performing verification and correction words of a document or data entry field written in the two or more languages based on the selected two or more languages using the one or more spelling dictionaries and spelling rules.

14. A computer program product for multi-language word spelling verification and correction including one or more computer readable instructions embedded on a computer readable medium and configured to cause one or more computer processors to perform the steps of:
providing one or more spelling dictionaries and spelling rules for two or more languages;
selecting two or more languages for use with the one or more spelling dictionaries and spelling rules; and
performing verification and correction words of a document or data entry field written in the two or more languages based on the selected two or more languages using the one or more spelling dictionaries and spelling rules.
